(19) United States
(12) Patent Application Publication
(10) Pub. No.: US 2026/0341570 A1
(43) Pub. Date: Oct. 29, 2026

(54) MULTILAYER INDUCTOR

(71) Applicant: Murata Manufacturing Co., Ltd., Kyoto-fu (JP)

(72) Inventors: Katsuhisa IMADA, Nagaokakyo-shi (JP); Atsuo HIRUKAWA, Nagaokakyo-shi (JP)

(73) Assignee: Murata Manufacturing Co., Ltd., Kyoto-fu (JP)

(21) Appl. No.: 19/447,449

(22) Filed: Jan. 13, 2026

(30) Foreign Application Priority Data
Apr. 28, 2025 (JP) 2025-074829

(51) Int. Cl. H01F 17/00

(52) U.S. Cl. CPC H01F 17/0013; H01F 2017/0073

(57) ABSTRACT

A multilayer inductor includes an element body formed by stacking multiple insulating layers in a stacking direction, and an inductor disposed inside the element body. The inductor includes inductor conductor layers stacked in the stacking direction together with the insulating layers. When looking at a cross section of the element body and the inductor parallel to the stacking direction and perpendicular to the direction in which the inductor conductor layers extend, at least one cross section of the inductor conductor layers includes a columnar portion in contact with the insulating layers on both a first main surface and a second main surface facing each other in the stacking direction, and two or more voids separated from each other by the columnar portion in a direction along the first main surface are provided between at least the first main surface of the inductor conductor layer and the insulating layers.

### CROSS-REFERENCE TO RELATED APPLICATION

This application claims benefit of priority to Japanese Patent Application No. 2025-074829, filed Apr. 28, 2025, the entire content of which is incorporated herein by reference.

### BACKGROUND

### Technical Field

The present disclosure relates to a multilayer inductor.

### Background Art

Japanese Unexamined Patent Application Publication No. 2015-191904 discloses a multilayer coil component including an element body, a coil, and a plurality of terminal electrodes. The element body is formed by stacking a plurality of magnetic layers. The coil is configured by electrically connecting a plurality of coil conductors and is disposed inside the element body. The plurality of terminal electrodes are disposed on an outer surface of the element body and electrically connected to the coil. Each coil conductor includes a portion around the periphery of the coil conductor that is in contact with the element body and a portion around the periphery of the coil conductor that is spaced apart from the element body.

### SUMMARY

In the multilayer coil component described in Japanese Unexamined Patent Application Publication No. 2015-191904, voids are formed in the portions where the coil conductors are spaced apart from the element body. As a result, even if the coil conductors undergo thermal expansion in a high-temperature environment, the voids can absorb the expansion, and therefore the generation of internal stress in the element body due to the expanded coil conductors can be suppressed.

However, for example, when mounting the multilayer coil component described in Japanese Unexamined Patent Application Publication No. 2015-191904 on a substrate, a large stress is applied to the coil conductor due to the impact of a mounter, and this makes the voids more likely to collapse. As a result, there is a risk of issues occurring such as the coil conductors being crushed or generation of cracks in the element body.

This problem is not limited to multilayer coil components in which a spiral coil formed by stacking multiple coil conductors is disposed inside an element body, but is a problem common to multilayer inductors in which an inductor formed by stacking multiple inductor conductor layers is disposed inside an element body.

Therefore, the present disclosure provides a multilayer inductor in which the stress applied to inductor conductor layers is small even when voids are provided between the inductor conductor layers and insulating layers.

A multilayer inductor of the present disclosure includes an element body and an inductor. The element body is formed by stacking a plurality of insulating layers in a stacking direction. The inductor is disposed inside the element body. The inductor includes an inductor conductor layer stacked together with the insulating layers in the stacking direction. When looking at a cross section of the element body and the inductor that is parallel to the stacking direction and perpendicular to a direction in which the inductor conductor layer extends, at least one cross section of the inductor conductor layer includes a columnar portion in contact with the insulating layers at both a first main surface and a second main surface facing each other in the stacking direction, and two or more voids separated from each other by the columnar portion in a direction along the first main surface are provided between at least the first main surface of the inductor conductor layer and the insulating layers.

According to the present disclosure, a multilayer inductor can be provided in which the stress acting on inductor conductor layers is small even when voids are provided between the inductor conductor layers and the insulating layers.

### BRIEF DESCRIPTION OF THE DRAWINGS

FIG. 1 is a cross-sectional view schematically illustrating an example of a multilayer inductor according to a First Embodiment of the present disclosure;

FIG. 2 is a perspective view schematically illustrating an example of the multilayer inductor according to the First Embodiment of the present disclosure;

FIG. 3 is an example of a cross-sectional view of the multilayer inductor taken along line III-III in FIG. 1;

FIG. 4 is an enlarged cross-sectional view of a portion indicated by IV in FIG. 1;

FIG. 5 is a schematic diagram for explaining a stress simulation;

FIG. 6A illustrates the results of a stress simulation for a multilayer inductor in which there are no columnar portions in the inductor conductor layers, and FIG. 6B illustrates the results of a stress simulation for a multilayer inductor in which columnar portions are present at the centers of the inductor conductor layers.

FIG. 7 is a cross-sectional view schematically illustrating an example of a multilayer inductor according to a Second Embodiment of the present disclosure;

FIG. 8 is an enlarged cross-sectional view of a portion indicated by VIII in FIG. 7;

FIG. 9 is a cross-sectional view schematically illustrating an example of a multilayer inductor according to a Third Embodiment of the present disclosure;

FIG. 10 is an example of a cross-sectional view of the multilayer inductor taken along line X-X in FIG. 9;

FIG. 11 is an enlarged cross-sectional view of a portion indicated by XI in FIG. 9;

FIG. 12 is a schematic diagram illustrating a reference line for measuring the line width of a void;

FIG. 13 is a schematic diagram illustrating a method for measuring the line width of a void;

FIG. 14A illustrates the results of a stress simulation for a multilayer inductor in which columnar portions are located at the center of inductor conductor layers, and FIG. 14B illustrates the results of a stress simulation for a multilayer inductor in which columnar portions are positioned toward the outer periphery of the inductor conductor layers;

FIG. 15 is a cross-sectional view schematically illustrating an example of a multilayer inductor according to a Fourth Embodiment of the present disclosure;

FIG. 16 is an example of a cross-sectional view of the multilayer inductor taken along line XVI-XVI in FIG. 15;

FIG. 17 is an enlarged cross-sectional view of a portion indicated by XVII in FIG. 15;

FIG. 18A illustrates the results of a stress simulation for a multilayer inductor in which columnar portions are located at the centers of inductor conductor layers, and FIG. 18B illustrates the results of a stress simulation for a multilayer inductor in which the columnar portions are positioned toward the inner peripheries of the inductor conductor layers;

FIG. 19 is a graph illustrating the relationship between the void line width ratio on the inner periphery side and the stress applied to an inductor conductor layer;

FIGS. 20A, 20B, and 20C are schematic diagrams for explaining the relationship between the position of columnar portions and the stress applied to inductor conductor layers;

FIG. 21 is a cross-sectional view schematically illustrating an example of a multilayer inductor according to a Fifth Embodiment of the present disclosure;

FIG. 22 is an example of a cross-sectional view of the multilayer inductor taken along line XXII-XXII in FIG. 21;

FIG. 23 is an enlarged cross-sectional view of a portion indicated by XXIII in FIG. 21;

FIG. 24A illustrates the results of a stress simulation for a multilayer inductor in which columnar portions are located at the centers of inductor conductor layers, and FIG. 24B illustrates the results of a stress simulation for a multilayer inductor in which columnar portions are positioned toward both the outer periphery and the inner periphery of inductor conductor layers;

FIG. 25 is a graph illustrating the relationship between the void line width ratio on the inner periphery side and the stress applied to inductor conductor layers;

FIG. 26 is a cross-sectional view schematically illustrating an example of a multilayer inductor according to a Sixth Embodiment of the present disclosure;

FIG. 27 is an enlarged cross-sectional view of a portion indicated by XXVII in FIG. 26;

FIGS. 28A and 28B illustrate the results of a stress simulation when the void line width ratio of an entire conductor layer is changed in a multilayer inductor in which columnar portions are located at the centers of the inductor conductor layers;

FIG. 29 is a graph illustrating the relationship between the void line width ratio of an entire conductor layer and the stress applied to the inductor conductor layer in a multilayer inductor in which columnar portions are located at the centers of the inductor conductor layers;

FIG. 30 is a graph illustrating the relationship between the void line width ratio of an entire conductor layer and the stress applied to the inductor conductor layer in multilayer inductors in which the columnar portions are located at different positions;

FIG. 31 is a cross-sectional view schematically illustrating an example of a multilayer inductor according to a Seventh Embodiment of the present disclosure;

FIG. 32A illustrates the results of a stress simulation for a multilayer inductor in which the number of voids separated by columnar portions is two, and FIG. 32B illustrates the results of a stress simulation for a multilayer inductor in which the number of voids separated by columnar portions is three;

FIGS. 33A and 33B are schematic diagrams illustrating an example of a printing process;

FIG. 34 is a schematic view illustrating an example of a stacking and pressure bonding process;

FIG. 35 is a schematic diagram illustrating an example of a firing process;

FIGS. 36A, 36B, and 36C are schematic diagram illustrating another example of a printing process;

FIG. 37 is a schematic diagram illustrating another example of a stacking and pressure bonding process;

FIG. 38 is a schematic diagram illustrating another example of a firing process;

FIG. 39A is a top cross-sectional view schematically illustrating a First Modification of a multilayer inductor of the present disclosure, and FIG. 39B is a side cross-sectional view schematically illustrating the First Modification of a multilayer inductor of the present disclosure; and

FIG. 40A is a top cross-sectional view schematically illustrating a Second Modification of a multilayer inductor of the present disclosure, and FIG. 40B is a side cross-sectional view schematically illustrating the second modification of a multilayer inductor of the present disclosure.

### DETAILED DESCRIPTION

A multilayer inductor of the present disclosure will be described below. Note that the present disclosure is not limited to the following embodiments, and can be applied with appropriate modifications within a scope that does not change the gist of the present disclosure. Furthermore, combinations of two or more of the individual preferred configurations described in the following embodiments are also included in the present disclosure.

A multilayer inductor of the present disclosure is characterized in that, when looking at a cross section of an element body and an inductor that is parallel to a stacking direction and perpendicular to a direction in which inductor conductor layers extend, two or more voids that are separated from each other in a direction along the first main surface by a columnar portion are provided between at least a first main surface of an inductor conductor layer and an insulating layer. Note that a multilayer inductor of the present disclosure does not need to satisfy the above characteristics in all cross sections parallel to the stacking direction and perpendicular to the direction in which the inductor conductor layers extend, and it is sufficient that the above characteristics are satisfied in any one cross section.

The following embodiments are merely examples, and it goes without saying that parts of the configurations illustrated in different embodiments can be substituted for one another or combined with one another. From the Second Embodiment onwards, description of matters common to the First Embodiment will be omitted, and only differences will be described. In particular, similar effects resulting from similar configurations will not be mentioned in every embodiment.

In each of the embodiments described below, two or more voids separated by columnar portions are provided between the first main surface of an inductor conductor layer and the insulating layers in all cross sections of the inductor conductor layers present in the cross sections of the element body and inductor in the above-mentioned directions. However, as long as two or more voids separated by columnar portions are provided between the first main surface of the inductor conductor layer and the insulating layers in at least one cross section of the inductor conductor layers, there may be a cross section of an inductor conductor layer in which no voids are provided between the first main surface of the inductor conductor layer and the insulating layers, or there may be a cross section of an inductor conductor layer in which only one void is provided.

In addition, in each of the embodiments described below, no voids are provided between a second main surface of an inductor conductor layer and the insulating layers. However, as long as two or more voids separated by columnar portions are provided between the first main surface of an inductor conductor layer and insulating layers in at least one cross section of the inductor conductor layers, there may be a cross section of an inductor conductor layer in which a void is provided between the second main surface of the inductor conductor layer and the insulating layers. In this case, two or more voids separated by columnar portions in a direction along the second main surface may be provided between the second main surface of an inductor conductor layer and the insulating layers, or only one void may be provided.

In the following description, when not making any particular distinction between individual embodiments, we will simply refer to “a multilayer inductor of the present disclosure”.

In this specification, terms indicating the relationship between elements (e.g., “perpendicular”, “parallel”, “orthogonal”, etc.) and terms indicating the shape of elements are not expressions that only express a strict meaning, but are rather expressions that also include substantially equivalent ranges, for example, differences of a few percent.

The drawings illustrated below are schematic diagrams, and the dimensions, aspect ratios, and so on may differ from those of an actual product. In the drawings, the same or equivalent parts will be designated by the same reference symbols. In addition, the same elements will be designated by the same reference symbols in each drawing, and duplicate descriptions will be omitted.

### First Embodiment

In a multilayer inductor according to a First Embodiment of the present disclosure, in at least one cross section of inductor conductor layers, two voids separated by a columnar portion are provided between a first main surface of an inductor conductor layer and insulating layers.

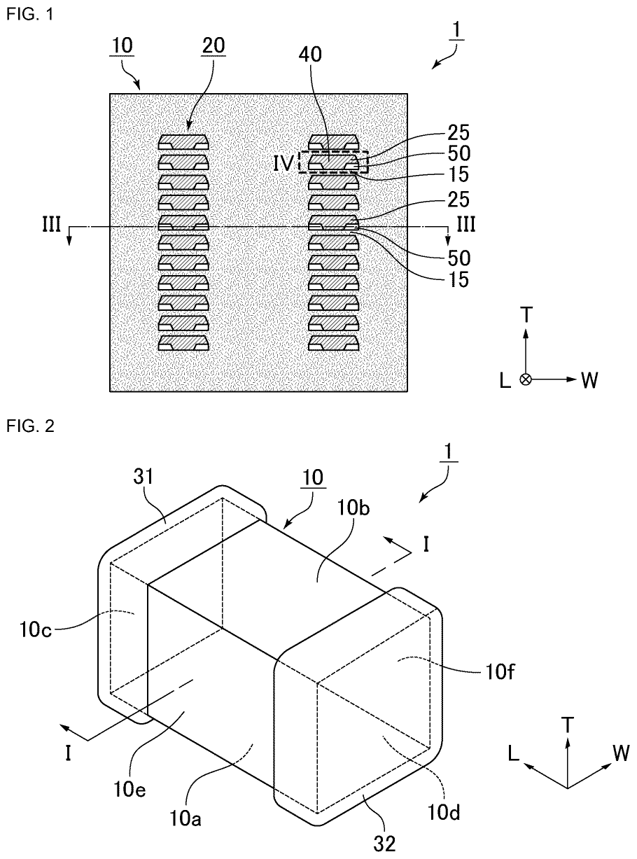

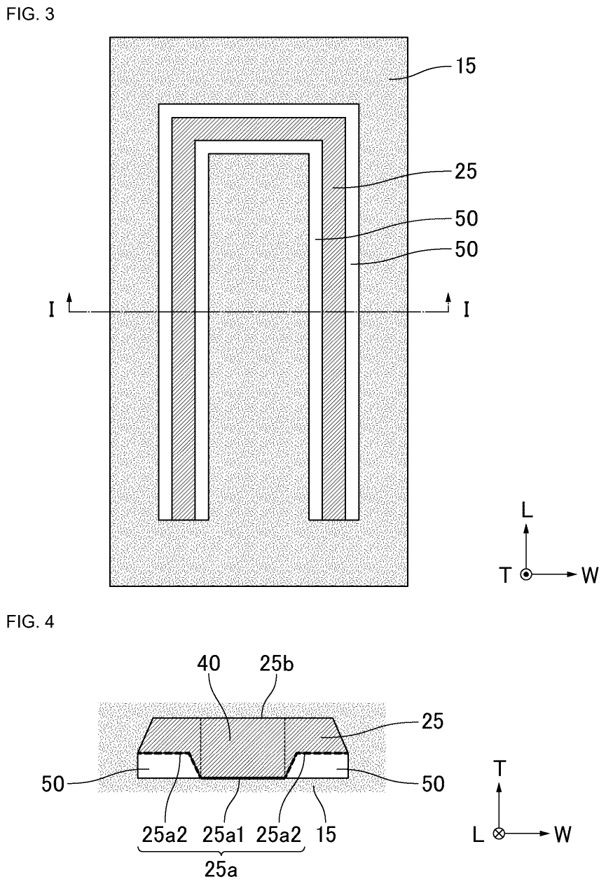

FIG. 1 is a cross-sectional view schematically illustrating an example of a multilayer inductor according to the First Embodiment of the present disclosure. FIG. 2 is a perspective view schematically illustrating an example of the multilayer inductor according to the First Embodiment of the present disclosure. FIG. 3 is an example of a cross-sectional view of the multilayer inductor taken along line III-III in FIG. 1. Note that FIG. 1 corresponds to a cross-sectional view of the multilayer inductor taken along line I-I in FIGS. 2 and 3.

A multilayer inductor 1 illustrated in FIGS. 1 and 2 includes an element body 10 and an inductor 20 (see FIG. 1) disposed inside the element body 10. In the example illustrated in FIG. 2, the multilayer inductor 1 further includes a first external electrode 31 and a second external electrode 32.

The element body 10 is formed by stacking a plurality of insulating layers 15 (see FIGS. 1 and 3) in a stacking direction T. In reality, however, the boundaries between the insulating layers 15 are not clearly visible, as illustrated in FIG. 1.

The insulating layers 15 may be composed of a magnetic material such as ferrite.

In FIGS. 1 to 3, the length direction, width direction, and stacking direction of the multilayer inductor 1 and element body 10 are illustrated as an L direction, a W direction, and a T direction, respectively. The length direction L, the width direction W, and the stacking direction T are preferably perpendicular to one another. The mounting surface of the multilayer inductor 1 is, for example, a surface (LW surface) parallel to the length direction L and the width direction W.

In the example illustrated in FIG. 2, the element body 10 has a rectangular parallelepiped shape. In this case, the element body 10 has a first main surface 10a and a second main surface 10b facing each other in the stacking direction T, a first end surface 10c and a second end surface 10d facing each other in the length direction L perpendicular to the stacking direction T, and a first side surface 10e and a second side surface 10f facing each other in a width direction W perpendicular to the stacking direction T and the length direction L.

The corners and ridges of the element body 10 may be rounded. A corner is a portion where three surfaces of the element body 10 intersect, and a ridge is a portion where two surfaces of the element body 10 intersect.

The inductor 20 includes inductor conductor layers 25 (see FIGS. 1 and 3) stacked together with the insulating layers 15 in the stacking direction T.

In the example illustrated in FIGS. 1 and 3, the inductor 20 is configured by electrically connecting a plurality of inductor conductor layers 25 (see FIGS. 1 and 3) stacked together with the insulating layers 15 in the stacking direction T. The inductor conductor layers 25 adjacent to each other in the stacking direction T are electrically connected to each other through via conductors (not illustrated). Accordingly, the inductor 20 is configured by electrically connecting a plurality of inductor conductor layers 25, which are stacked together with the insulating layers 15 in the stacking direction T, through via conductors (not illustrated). When the inductor 20 is viewed in a perspective view in the stacking direction T, the inductor conductor layers 25 have a spiral shape that winds around a coil axis (not illustrated) that is parallel to the stacking direction T.

Examples of materials that can be used to form the inductor conductor layers 25 include conductive materials such as Au, Ag, Pd, Cu, and Ni. In the example illustrated in FIG. 1, the cross-sectional shape of the inductor conductor layers 25 is substantially trapezoidal, but the cross-sectional shape of the inductor conductor layers 25 is not particularly limited. For example, the cross-sectional shape of the inductor conductor layers 25 may be substantially elliptical.

The first external electrode 31 and the second external electrode 32 are provided on the outer surface of the element body 10 and are electrically connected to the inductor 20.

In the example illustrated in FIG. 2, the first external electrode 31 is disposed to cover the first end surface 10c of the element body 10 and extend from the first end surface 10c to cover part of the first main surface 10a, part of the second main surface 10b, part of the first side surface 10e, and part of the second side surface 10f. On the other hand, the second external electrode 32 is disposed to cover the second end surface 10d of the element body 10 and extend from the second end surface 10d to cover part of the first main surface 10a, part of the second main surface 10b, part of the first side surface 10e, and part of the second side surface 10f.

The inductor 20 and the first external electrode 31 are electrically connected to each other at the first end surface 10c of the element body 10, and the inductor 20 and the second external electrode 32 are electrically connected to each other at the second end surface 10d of the element body 10.

Examples of materials that can be used to form the first external electrode 31 and the second external electrode 32 include conductive materials such as Au, Ag, Pd, Cu, and Ni. Furthermore, plating layers may be provided on the surfaces of the first external electrode 31 and the second external electrode 32.

FIG. 4 is an enlarged cross-sectional view of a portion indicated by IV in FIG. 1.

As illustrated in FIG. 1, when looking at a cross section of the element body 10 and the inductor 20 parallel to the stacking direction T and perpendicular to the direction in which the inductor conductor layers 25 extend (length direction L in FIG. 1), as illustrated in FIG. 4, the cross section of each inductor conductor layer 25 includes a columnar portion 40 that is in contact with the insulating layers 15 at both a first main surface 25a and a second main surface 25b that face each other in the stacking direction T, and two voids 50 that are separated by the columnar portion 40 in a direction along the first main surface 25a (width direction W in FIG. 4) are provided between the first main surface 25a of the inductor conductor layer 25 and the insulating layers 15. As illustrated in FIG. 4, the first main surface 25a of the inductor conductor layer 25 includes not only a portion 25a1 that is in contact with the insulating layer 15 (the portion indicated by a thick solid line in FIG. 4), but also portions 25a2 that are in contact with the voids 50 (the portions indicated by a thick dashed line in FIG. 4). Furthermore, although not illustrated in FIG. 4, if voids 50 were provided between the second main surface 25b of the inductor conductor layer 25 and the insulating layers 15, the second main surface 25b of the inductor conductor layer 25 would include not only a portion in contact with the insulating layer 15 but also portions in contact with the voids 50.

In the example illustrated in FIG. 1, all cross sections of the inductor conductor layers 25 satisfies the configuration illustrated in FIG. 4, but it is sufficient that at least one cross section of the inductor conductor layers 25 satisfies the configuration illustrated in FIG. 4. Furthermore, the way in which the cross section is taken is not limited to the WT cross section (a cross section parallel to the width direction W and the stacking direction T) illustrated in FIG. 1 as long as the cross section is a cross section parallel to the stacking direction T and perpendicular to the direction in which the inductor conductor layers 25 extend, and it is sufficient that at least one cross section satisfies the configuration illustrated in FIG. 4. The same applies in subsequent embodiments.

In the multilayer inductor 1, even when the voids 50 are provided between the inductor conductor layers 25 and the insulating layers 15, the presence of the columnar portions 40 in the inductor conductor layers 25 can reduce the stress applied to the inductor conductor layers 25. Therefore, for example, when mounting the multilayer inductor 1 on a substrate, it is possible to prevent the inductor conductor layers 25 from being crushed due to the impact of a mounter (mounting machine) and the occurrence of cracks in the element body 10.

Furthermore, unlike in a configuration like that in Japanese Unexamined Patent Application Publication No. 2015-191904 in which the voids 50 are provided over the entirety of the first main surface 25a of each inductor conductor layer 25 (i.e., a configuration in which the first main surface 25a of the inductor conductor layer 25 is not in contact with the insulating layers 15), since the columnar portion 40 is present in the inductor conductor layer 25, heat dissipation from the columnar portion 40 is increased, thereby improving the heat dissipation performance of the entire multilayer inductor 1.

In the example illustrated in FIGS. 1 and 4, the columnar portion 40 is present at the center of the inductor conductor layer 25, and the voids 50 are provided at both ends of the inductor conductor layer 25 between the first main surface 25a of the inductor conductor layer 25 and the insulating layers 15. By providing the voids 50 between the inductor conductor layer 25 and the insulating layers 15, stress generated due to differences in shrinkage between the insulating layers 15 and the inductor conductor layer 25 during firing is alleviated.

Hereafter, we will describe the results of stress simulations carried out to confirm the effect of the columnar portions 40 in reducing stress.

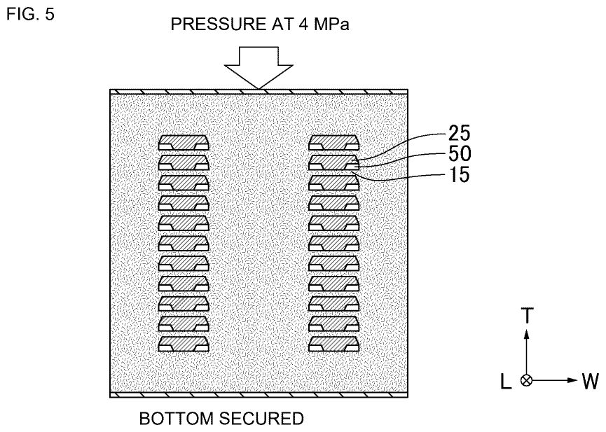

FIG. 5 is a schematic diagram for explaining stress simulation.

As illustrated in FIG. 5, for a multilayer inductor in which the voids 50 are provided between the inductor conductor layers 25 and the insulating layers 15, simulation software was used to calculate the stress acting on the insulating layers 15 and the inductor conductor layers 25. The specific conditions are as follows:
Insulating layers: ferrite
Inductor conductor layers: 100% Ag electrodes
Software used: Femtet (registered trademark) manufactured by Murata Software Co., Ltd.
Body size: 1608 size (1.6 mm×0.8 mm)
Pressurization pressure: 4 MPa pressure was applied to top
Fixing conditions: bottom of element body fixed (assuming there is a plate below the element body)
   The top and sides are free to analyze
Analysis dimensions: two-dimensional analysis
Young's modulus: Ferrite: 142.3 GPa :Ag: 73.2 GPa

### Poisson's Ratio: Ferrite: 0.33:Ag: 0.38

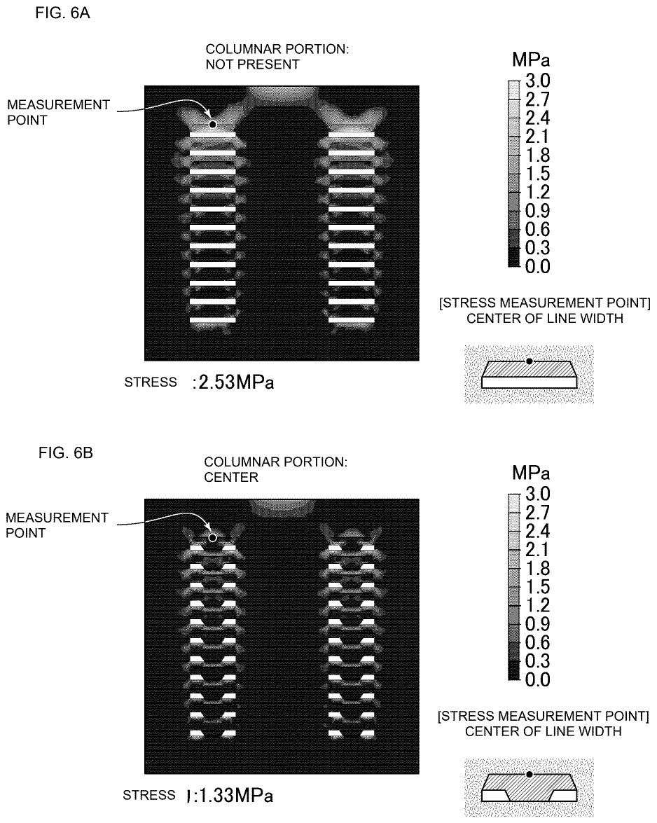

FIG. 6A illustrates the results of a stress simulation for a multilayer inductor in which no columnar portions are present in the inductor conductor layers. FIG. 6B illustrates the results of a stress simulation for a multilayer inductor in which columnar portions are present at the centers of the inductor conductor layers.

From the results illustrated in 6A and 6B, it can be confirmed that the stress acting on the inductor conductor layers is smaller in the configuration in which the columnar portions are present in the inductor conductor layers than in the configuration in which columnar portions are not present in the inductor conductor layers. Note that, as illustrated in FIGS. 6A and 6B, the stress measurement point is located at the center of the line width of the top surface (the second main surface 25b in FIG. 4) of an inductor conductor layer.

### Second Embodiment

In a multilayer inductor according to a Second Embodiment of the present disclosure, a coating layer containing an insulating material is provided on at least a part of the surface of an inductor conductor layer between the inductor conductor layer and the voids.

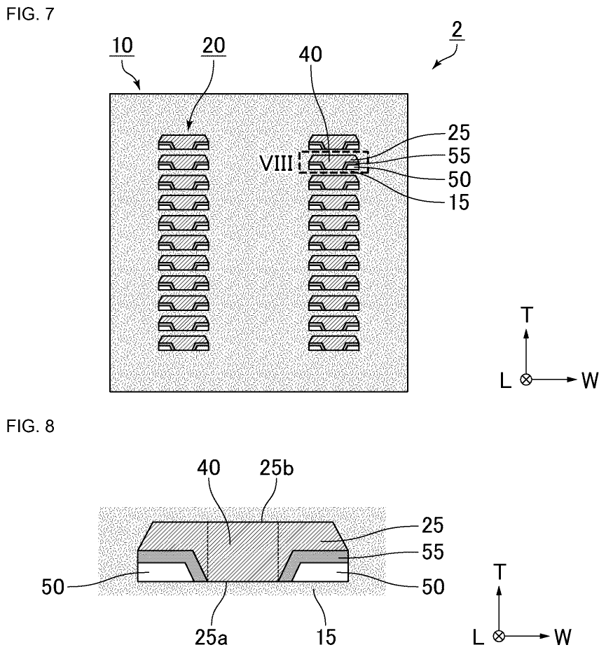

FIG. 7 is a cross-sectional view schematically illustrating an example of the multilayer inductor according to the Second Embodiment of the present disclosure. FIG. 8 is an enlarged cross-sectional view of a portion indicated by VIII in FIG. 7.

In a multilayer inductor 2 illustrated in FIG. 7, similarly to the multilayer inductor 1 illustrated in FIG. 1, when looking at a cross section of the element body 10 and the inductor 20 parallel to the stacking direction T and perpendicular to the direction in which the inductor conductor layers 25 extend (length direction L in FIG. 7), as illustrated in FIG. 8, the cross section of each inductor conductor layer 25 includes the columnar portion 40 that is in contact with the insulating layers 15 at both the first main surface 25a and the second main surface 25b facing each other in the stacking direction T, and two voids 50 that are separated by the columnar portion 40 in a direction along the first main surface 25a (width direction W in FIG. 8) are provided between the first main surface 25a of the inductor conductor layer 25 and the insulating layers 15.

Furthermore, in the multilayer inductor 2, a coating layer 55 containing an insulating material is provided on at least a part of the surface of the inductor conductor layer 25 between the inductor conductor layer 25 and the voids 50.

In the example illustrated in FIG. 7, all cross sections of the inductor conductor layers 25 satisfy the configuration illustrated in FIG. 8, but it is sufficient that at least one cross section of the inductor conductor layers 25 satisfies the configuration illustrated in FIG. 8.

The coating layer 55 may be provided across the entire surface of the inductor conductor layer 25 between the inductor conductor layer 25 and the voids 50, or may be provided on only part of the surface. In the example illustrated in FIG. 8, the coating layer 55 is provided on the surface of the inductor conductor layer 25 between the inductor conductor layer 25 and the voids 50 at both ends of the voids 50, but the coating layer 55 may be provided only on the surface of the inductor conductor layer 25 at either one of the sides where the voids 50 are located.

By providing the coating layer 55 containing an insulating material on the surface of the inductor conductor layer 25, the heat dissipation of the multilayer inductor 2 is improved compared to the multilayer inductor 1. In general, insulating materials have higher thermal conductivity than air. Therefore, it is thought that heat dissipation improves as the contact area between the inductor conductor layer 25 and the coating layer 55 increases.

The insulating material contained in the coating layer 55 preferably contains a magnetic material such as ferrite, etc. When the coating layer 55 contains a magnetic material, the impedance of the multilayer inductor 2 increases.

The insulating material contained in the coating layer 55 preferably contains a material having the same composition as the insulating layers 15, and more preferably contains a magnetic material having the same composition as the insulating layers 15. For example, the coating layer 55 preferably contains ferrite having the same composition as the insulating layers 15. Using the same material as the insulating layers 15 as the insulating material contained in the coating layer 55 can reduce the complexity of manufacturing.

In this specification, “having the same composition” means that the types of elements contained in the materials are the same. As long as the types of elements are the same, the contents of the elements may be different.

The thickness of the coating layer 55 is not particularly limited, and may be smaller than the thickness of the voids 50, larger than the thickness of the voids 50, or the same as the thickness of the voids 50. Furthermore, the coating layer 55 does not have to cover the entire surface of the inductor conductor layer 25 in all cross sections, as long as it covers at least part of the inductor conductor layer 25.

### Third Embodiment

In a multilayer inductor according to a Third Embodiment of the present disclosure, when looking at a cross section of the element body and the inductor parallel to the stacking direction and perpendicular to the direction in which the inductor conductor layers extend, in at least one pair of cross sections of the inductor conductor layers located in the same layer with the coil axis therebetween, the columnar portions present in the inductor conductor layers are both positioned toward to the outer peripheries of the inductor conductor layers.

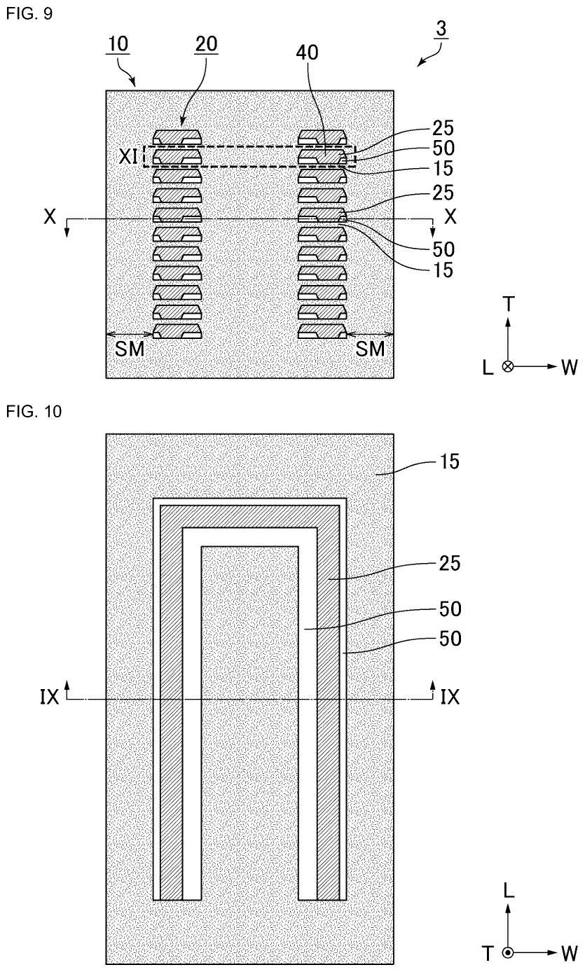

FIG. 9 is a cross-sectional view schematically illustrating an example of the multilayer inductor according to the Third Embodiment of the present disclosure. FIG. 10 is an example of a cross-sectional view of the multilayer inductor taken along line X-X in FIG. 9. FIG. 9 corresponds to a cross-sectional view of the multilayer inductor taken along line IX-IX in FIG. 10.

In a multilayer inductor 3 illustrated in FIG. 9, similarly to the multilayer inductor 1 illustrated in FIG. 1, when the inductor 20 is viewed in a perspective view in the stacking direction T, as illustrated in FIG. 10, the inductor conductor layers 25 have a spiral shape that winds around a coil axis (not illustrated) that is parallel to the stacking direction T.

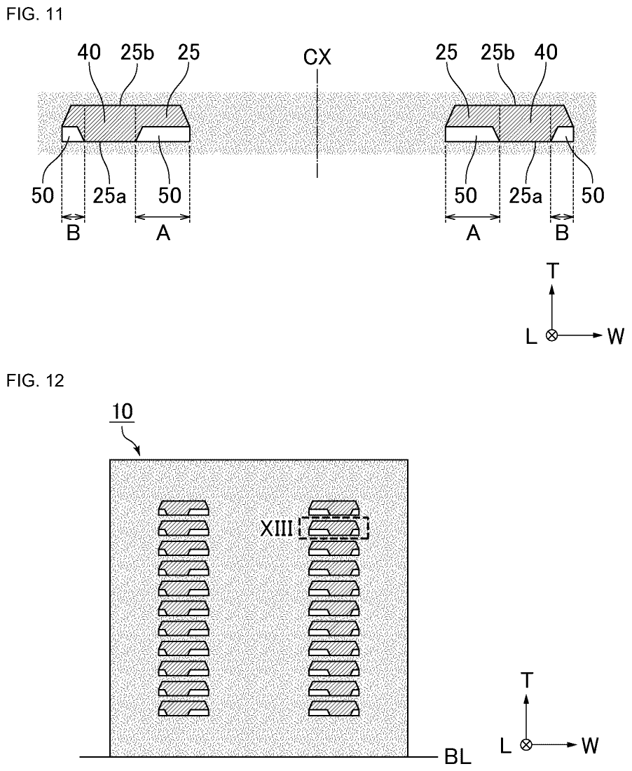

FIG. 11 is an enlarged cross-sectional view of a portion indicated by XI in FIG. 9.

As illustrated in FIG. 9, when a cross section of the element body 10 and the inductor 20 parallel to the stacking direction T and perpendicular to the direction in which the inductor conductor layers 25 extend (length direction L in FIG. 9) is viewed, the cross section of each inductor conductor layer 25 includes the columnar portion 40 in contact with the insulating layer 15 at both the first main surface 25a and the second main surface 25b facing each other in the stacking direction T, and, as illustrated in FIG. 11, two voids 50 separated by the columnar portion 40 in a direction along the first main surface 25a (width direction W in FIG. 11) are provided between the first main surface 25a of the inductor conductor layer 25 and the insulating layers 15.

Furthermore, as illustrated in FIG. 11, in cross sections of the inductor conductor layers 25 located in the same layer with a coil axis CX therebetween, the columnar portions 40 present in the inductor conductor layers 25 are both positioned toward the outer peripheries of the inductor conductor layers 25.

When the columnar portions 40 are positioned toward the outer peripheries of the inductor conductor layers 25, the voids 50 near the side surfaces of the element body 10 become smaller as illustrated in FIG. 9, and this makes it possible to suppress cracks from occurring in the side margin portions (the portions indicated by SM in FIG. 9) of the element body 10. This increases the reliability of the multilayer inductor 3.

In the example illustrated in FIG. 9, all cross sections of the inductor conductor layers 25 located in the same layers with the coil axis CX therebetween (see FIG. 11) satisfy the configuration illustrated in FIG. 11, but it is sufficient that at least one pair of cross sections of the inductor conductor layers 25 located in the same layer with the coil axis CX therebetween satisfies the configuration illustrated in FIG. 11. Furthermore, the way in which the cross sections are taken is not particularly limited as long as the cross sections are taken through the coil axis CX, and it is sufficient that at least one cross section satisfies the configuration illustrated in FIG. 11. The same applies in subsequent embodiments.

As illustrated in FIG. 11, in a cross section of the inductor conductor layers 25 in which the columnar portions 40 are positioned toward the outer peripheries of the inductor conductor layers 25, when the line width of the voids 50 located on the inner periphery side of the inductor conductor layers 25 is A and the line width of the voids 50 located on the outer periphery side of the inductor conductor layers 25 is B, the inner-periphery-side void line width ratio expressed as A/(A+B) is greater than 0.50, and may be, for example, 0.55 or higher, or 0.60 or higher. On the other hand, the inner periphery void line width ratio expressed as A/(A+B) is less than 1.0, and may be, for example, 0.95 or lower, or may be 0.90 or lower.

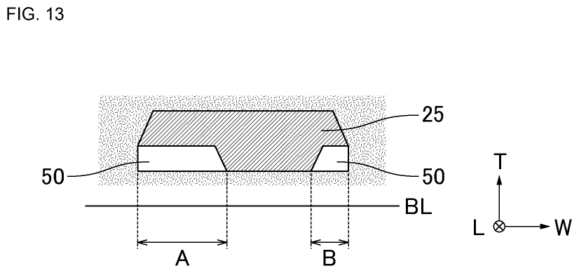

A method for measuring the line width of the voids 50 will be described below with reference to FIGS. 12 and 13.

FIG. 12 is a schematic diagram illustrating a reference line used for measuring the line width of the voids.

First, as illustrated in FIG. 12, a reference line BL is defined along the bottom of the outer shape of the element body 10.

FIG. 13 is a schematic diagram illustrating a method for measuring the line width of voids. FIG. 13 is an enlarged view of the portion indicated by XIII in FIG. 12.

Next, as illustrated in FIG. 13, the maximum length of each void 50 when projected onto the reference line BL is defined as the line width of the void 50. FIG. 13 illustrates a line width A of the void 50 located on the inner periphery side of the inductor conductor layer 25 and a line width B of the void 50 located on the outer periphery side of the inductor conductor layer 25.

In addition, if the void 50 protrudes from the inductor conductor layer 25, the length of the part protruding from the inductor conductor layer 25 is not included in the line width of the void 50.

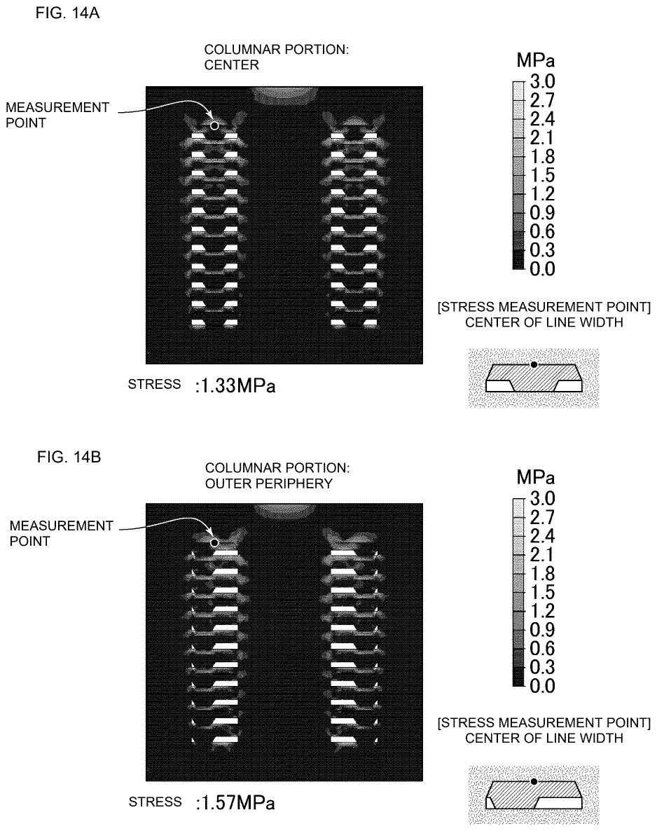

FIG. 14A illustrates the results of a stress simulation for a multilayer inductor in which columnar portions are present at the centers of the inductor conductor layers. FIG. 14B illustrates the results of a stress simulation for a multilayer inductor in which columnar portions are positioned toward the outer peripheries of the inductor conductor layers.

From the results in FIGS. 14A and 14B, in the configuration in which the columnar portion is positioned toward the outer periphery of each inductor conductor layer, the stress acting on the inductor conductor layer is slightly larger than in the configuration in which the columnar portion is located at the center of the inductor conductor layer. However, the stress acting on the inductor conductor layer is smaller than in the configuration in which no columnar portion is present in the inductor conductor layers as illustrated in FIG. 6A.

### Fourth Embodiment

In a multilayer inductor according to a Fourth Embodiment of the present disclosure, when looking at a cross section of the element body and the inductor parallel to the stacking direction and perpendicular to the direction in which the inductor conductor layers extend, in at least one pair of cross sections of the inductor conductor layers located in the same layer with the coil axis therebetween, both of the columnar portions present in the inductor conductor layers are positioned toward the inner peripheries of the inductor conductor layers.

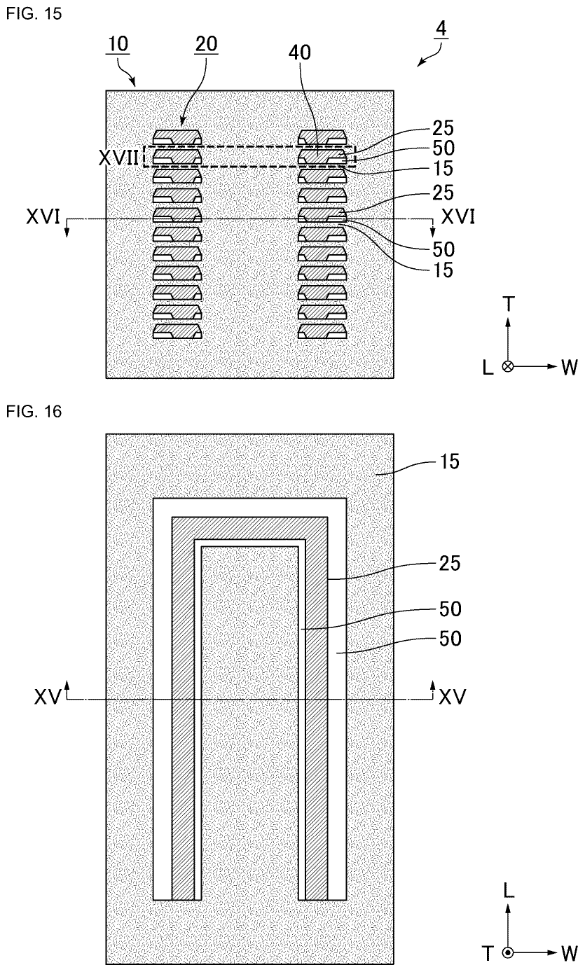

FIG. 15 is a cross-sectional view schematically illustrating an example of the multilayer inductor according to the Fourth Embodiment of the present disclosure. FIG. 16 is an example of a cross-sectional view of the multilayer inductor taken along line XVI-XVI in FIG. 15. FIG. 15 corresponds to the cross-sectional view of the multilayer inductor taken along line XV-XV in FIG. 16.

In a multilayer inductor 4 illustrated in FIG. 15, similarly to the multilayer inductor 1 illustrated in FIG. 1, when the inductor 20 is viewed in a perspective view in the stacking direction T, as illustrated in FIG. 16, the inductor conductor layer 25 has a spiral shape that winds around a coil axis (not illustrated) parallel to the stacking direction T.

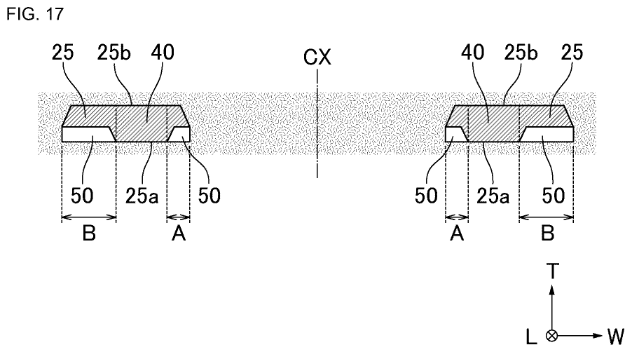

FIG. 17 is an enlarged cross-sectional view of a portion indicated by XVII in FIG. 15.

As illustrated in FIG. 15, when looking at a cross section of the element body 10 and the inductor 20 parallel to the stacking direction T and perpendicular to the direction in which the inductor conductor layers 25 extend (length direction L in FIG. 15), as illustrated in FIG. 17, the cross section of each inductor conductor layer 25 includes the columnar portion 40 in contact with the insulating layers 15 at both the first main surface 25a and the second main surface 25b facing each other in the stacking direction T, and two voids 50 separated by the columnar portion 40 in a direction along the first main surface 25a (width direction W in FIG. 17) are provided between the first main surface 25a of the inductor conductor layer 25 and the insulating layers 15.

Furthermore, as illustrated in FIG. 17, in the cross sections of the inductor conductor layers 25 located in the same layer with the coil axis CX therebetween, the columnar portions 40 present in the inductor conductor layers 25 are both positioned toward the inner peripheries of the inductor conductor layers 25.

Since the current flows along the inner periphery of each inductor conductor layer 25, the area through which the current passes is increased when the columnar portion 40 is positioned toward the inner periphery of the inductor conductor layer 25. Generation of heat due to the current can be suppressed.

In the example illustrated in FIG. 15, all cross sections of the inductor conductor layers 25 located in the same layer with the coil axis CX therebetween (see FIG. 17) satisfy the configuration illustrated in FIG. 17, but it is sufficient that at least one pair of cross sections of the inductor conductor layers 25 located in the same layer with the coil axis CX therebetween satisfies the configuration illustrated in FIG. 17.

As illustrated in FIG. 17, in a cross section of the inductor conductor layers 25 in which the columnar portions 40 are positioned toward the inner peripheries of the inductor conductor layers 25, when the line width of the voids 50 located on the inner periphery side of the inductor conductor layers 25 is A and the line width of the voids 50 located on the outer periphery side of the inductor conductor layers 25 is B, the inner-periphery-side void line width ratio expressed as A/(A+B) is less than 0.50, and may be, for example, 0.45 or less or 0.40 or less. On the other hand, the inner-periphery-side void line width ratio expressed as A/(A+B) is greater than 0, and may be, for example, 0.05 or more or 0.10 or more.

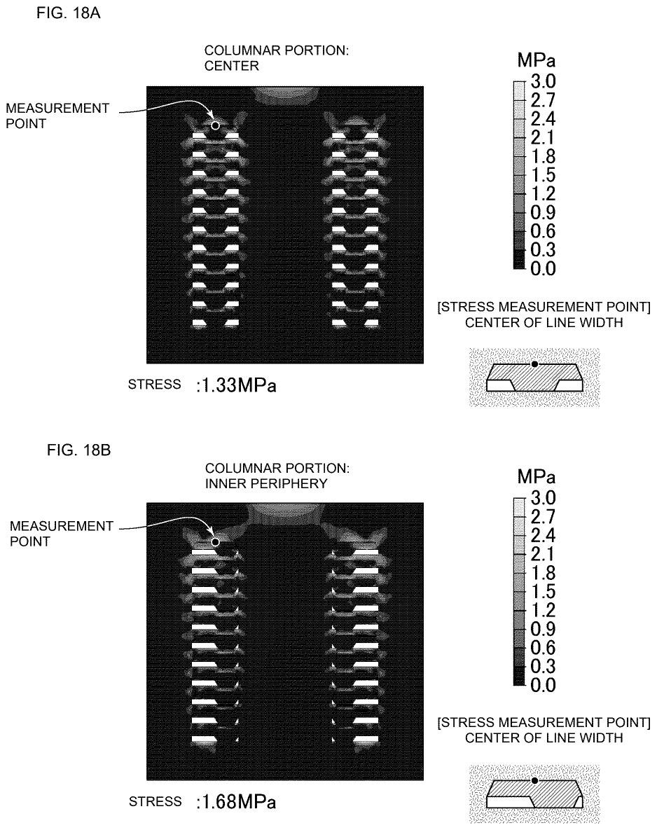

FIG. 18A illustrates the results of a stress simulation for a multilayer inductor in which columnar portions are located at the centers of the inductor conductor layers. FIG. 18B illustrates the results of a stress simulation for a multilayer inductor in which the columnar portions are located positioned toward the inner peripheries of the inductor conductor layers.

The results illustrated in FIGS. 18A and 18B indicate that in the configuration in which the columnar portions are positioned toward the inner peripheries of the inductor conductor layers, the stress acting on the inductor conductor layers is slightly larger than in the configuration in which the columnar portions are located at the centers of the inductor conductor layers. However, the stress acting on the inductor conductor layers is smaller than in the configuration illustrated in FIG. 6A in which no columnar portions are present in the inductor conductor layers.

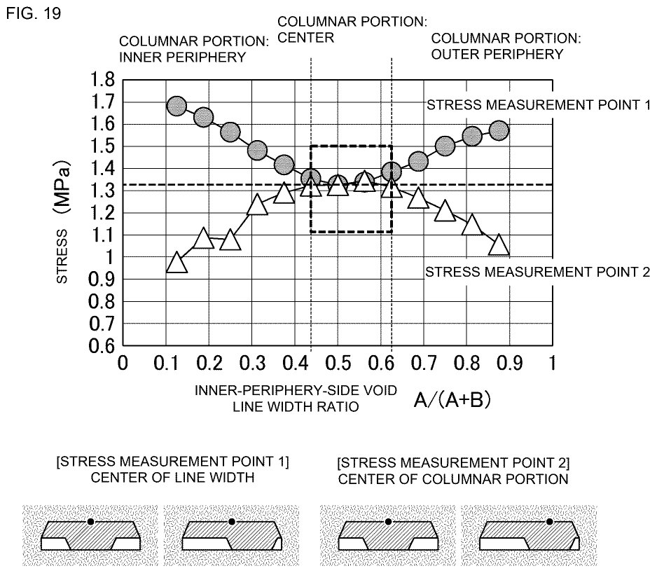

FIG. 19 is a graph illustrating the relationship between an inner-periphery-side void line width ratio and the stress applied to the inductor conductor layers.

From FIG. 19, we can see that at stress measurement point 1, where the stress measurement point is at the center of the line width on the top surface of the inductor conductor layer regardless of the position of the columnar portion, the stress applied to the inductor conductor layer can be reduced by setting the inner-periphery-side void line width ratio represented by A/(A+B) to 0.44 or more and 0.63 or less (i.e., from 0.44 to 0.63). On the other hand, at stress measurement point 2, where the stress measurement point is at the center of the columnar portion in accordance with the position of the columnar portion, the stress applied to the inductor conductor layer is stable when the inner-periphery-side void line width ratio represented by A/(A+B) is 0.44 or more and 0.63 or less (i.e., from 0.44 to 0.63).

For the above reasons, in at least one cross section of the inductor conductor layers 25 where the columnar portion 40 is located at the center of the inductor conductor layer 25, or at least one cross section of the inductor conductor layers 25 where the columnar portion 40 is positioned toward the outer periphery of the inductor conductor layer 25, or at least one cross section of the inductor conductor layers 25 where the columnar portion 40 is positioned toward the inner periphery of the inductor conductor layer 25, an inner-periphery-side void line width ratio, expressed as A/(A+B), is preferably 0.44 or more and 0.63 or less (i.e., from 0.44 to 0.63), where A is the line width of the void 50 located on the inner periphery side of the inductor conductor layer 25 and B is the line width of the void 50 located on the outer periphery side of the inductor conductor layer 25. In this case, the stress applied to the inductor conductor layer 25 can be further reduced. As a result, cracks caused by the voids 50 in the element body 10 can be reduced.

Here, the reason why the magnitude of the stress applied to the inductor conductor layer changes depending on the position of the columnar portion is not clear, but is presumed to be as follows.

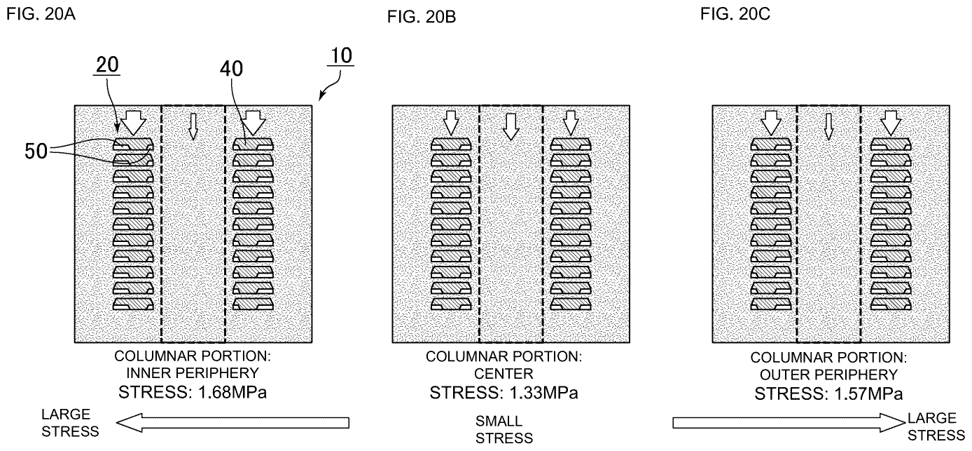

FIGS. 20A, 20B, and 20C are schematic diagrams for explaining the relationship between the positions of the columnar portions and the stress applied to the inductor conductor layers.

As illustrated by the dashed lines in FIGS. 20A, 20B, and 20C, the center of the inductor 20 is a large pillar of the element body 10, and is therefore inherently resistant to deformation due to pressure from above.

However, in a configuration in which the columnar portions 40 are positioned toward the inner periphery or the outer periphery of the inductor conductor layers as illustrated in FIG. 20A or 20C, it is estimated that the balance of stresses is more likely to be lost.

As illustrated in FIG. 20B, we believe that the closer the columnar portions 40 are positioned to the centers of the inductor conductor layers, the more evenly the stress is alleviated by the voids 50 located at both ends of the inductor conductor layers, making it easier to achieve a stress reduction effect. Furthermore, we believe that the closer the columnar portions 40 are positioned to the centers of the inductor conductor layers, the better the balance of the magnetic flux generated from the columnar portions 40 will be, resulting in improved characteristics.

### Fifth Embodiment

In a multilayer inductor according to a Fifth Embodiment of the present disclosure, when looking at a cross section of the element body and the inductor parallel to the stacking direction and perpendicular to the direction in which the inductor conductor layers extend, in at least one pair of cross sections of the inductor conductor layers located in the same layer with the coil axis therebetween, the columnar portion present in one inductor conductor layer is positioned toward the outer periphery of the inductor conductor layer, whereas the columnar portion present in the other inductor conductor layer is positioned toward the inner periphery of the inductor conductor layer.

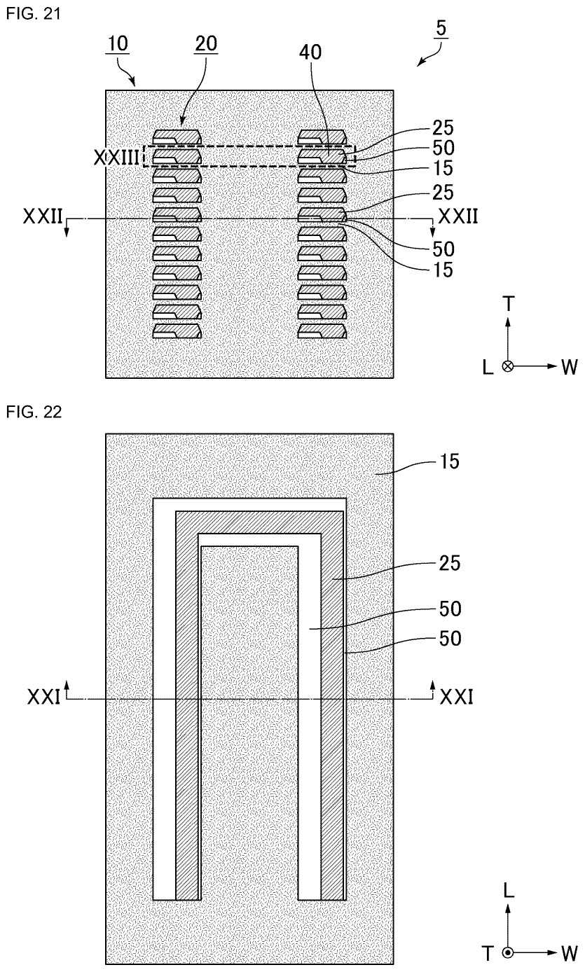

FIG. 21 is a cross-sectional view schematically illustrating an example of the multilayer inductor according to the Fifth Embodiment of the present disclosure. FIG. 22 is an example of a cross-sectional view of the multilayer inductor taken along line XXII-XXII in FIG. 21. FIG. 21 corresponds to the cross-sectional view of the multilayer inductor taken along line XXI-XXI in FIG. 22.

In a multilayer inductor 5 illustrated in FIG. 21, similarly to the multilayer inductor 1 illustrated in FIG. 1, when the inductor 20 is viewed in a perspective view in the stacking direction T, as illustrated in FIG. 22, the inductor conductor layers 25 have a spiral shape that winds around a coil axis (not illustrated) that is parallel to the stacking direction T.

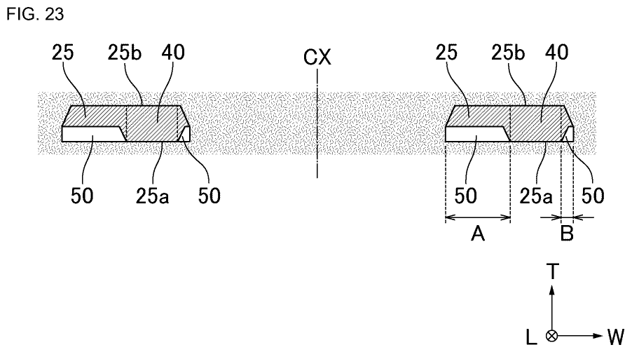

FIG. 23 is an enlarged cross-sectional view of a portion indicated by XXIII in FIG. 21.

As illustrated in FIG. 21, when looking at a cross section of the element body 10 and the inductor 20 parallel to the stacking direction T and perpendicular to the direction in which the inductor conductor layers 25 extend (length direction L in FIG. 21), the cross section of each inductor conductor layer 25 includes the columnar portion 40 in contact with the insulating layers 15 at both the first main surface 25a and the second main surface 25b facing each other in the stacking direction T, as illustrated in FIG. 23, and two voids 50 separated by the columnar portion 40 in a direction along the first main surface 25a (width direction W in FIG. 23) are provided between the first main surface 25a of the inductor conductor layer 25 and the insulating layers 15.

Furthermore, as illustrated in FIG. 23, in cross sections of the inductor conductor layers 25 located in the same layer with the coil axis CX therebetween, the columnar portion 40 present in one inductor conductor layer 25 is positioned toward the outer periphery of the inductor conductor layer 25, whereas the columnar portion 40 present in the other inductor conductor layer 25 is positioned toward the inner periphery of the inductor conductor layer 25.

In the example illustrated in FIG. 21, all the cross sections of the inductor conductor layers 25 located on the same layer with the coil axis CX therebetween (see FIG. 23) satisfy the configuration illustrated in FIG. 23, but it is sufficient that at least one pair of cross sections of the inductor conductor layers 25 located in the same layer with the coil axis CX therebetween satisfies the configuration illustrated in FIG. 23.

FIG. 24A illustrates the results of a stress simulation for a multilayer inductor in which columnar portions are located at the centers of the inductor conductor layers. FIG. 24B illustrates the results of a stress simulation for a multilayer inductor in which columnar portions are positioned toward both the outer periphery and the inner periphery of inductor conductor layers.

From the results in FIGS. 24A and 24B, in the configuration in which the columnar portions are positioned toward the outer periphery and the inner periphery of the inductor conductor layers, the stress acting on the inductor conductor layers is slightly larger than in the configuration in which the columnar portions are located at the centers of the inductor conductor layers. However, the stress acting on the inductor conductor layers is smaller than in the configuration in which no columnar portions are present in the inductor conductor layers as illustrated in FIG. 6A.

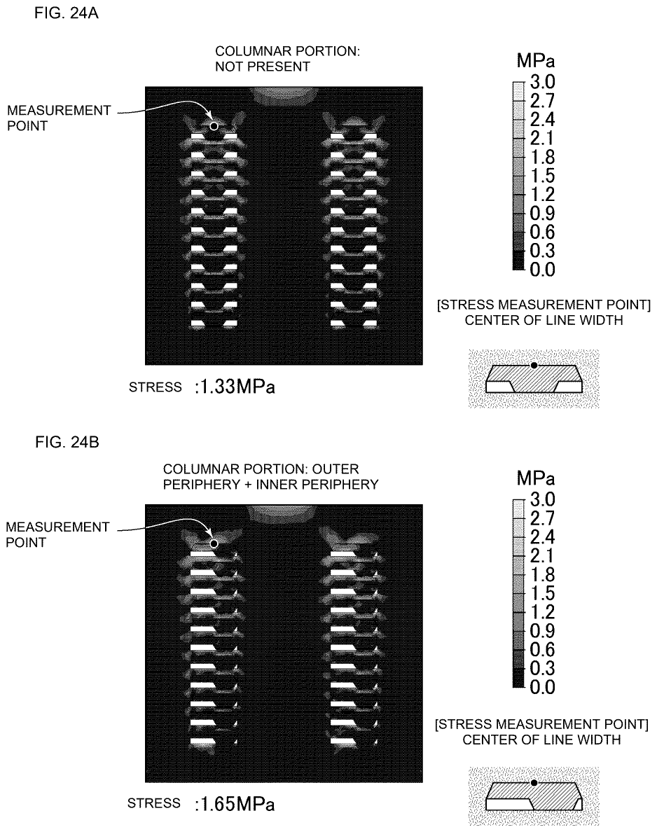

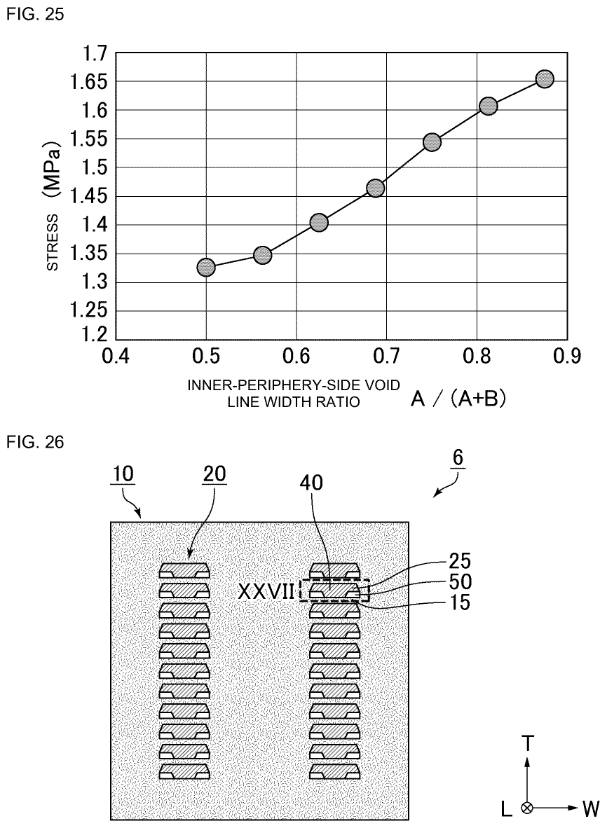

FIG. 25 is a graph illustrating the relationship between an inner-periphery-side void line width ratio and the stress applied to the inductor conductor layers.

FIG. 25 illustrates the relationship between an inner-periphery-side void line width ratio, expressed as A/(A+B), and the stress acting on the inductor conductor layers 25, when the line width of the void 50 located on the inner periphery side of the inductor conductor layer 25 is A and the line width of the void 50 located on the outer periphery side of the inductor conductor layer 25 is B in a cross section of the inductor conductor layer 25 in which the columnar portion 40 is positioned toward the outer periphery of the inductor conductor layer 25 as illustrated in FIG. 23.

As with the results illustrated in FIGS. 24A and 24B, FIG. 25 also indicates that in a configuration in which the columnar portions are positioned toward the outer periphery and the inner periphery of the inductor conductor layers, the stress acting on the inductor conductor layers is slightly greater than in a configuration in which the columnar portions are located at the center of the inductor conductor layers.

### Sixth Embodiment

In a multilayer inductor according to a Sixth Embodiment of the present disclosure, when looking at a cross section of the element body and the inductor parallel to the stacking direction and perpendicular to the direction in which the inductor conductor layers extend, in at least one cross section of the inductor conductor layers, when the total line width of the voids provided on the first main surface side of the inductor conductor layer is X and the line width of the inductor conductor layer is Y, a void line width ratio of an entire conductor layer, expressed as X/Y, is 0.16 or more and 0.96 or less (i.e., from 0.16 to 0.96).

FIG. 26 is a cross-sectional view schematically illustrating an example of the multilayer inductor according to the Sixth Embodiment of the present disclosure.

In a multilayer inductor 6 illustrated in FIG. 26, similarly to the multilayer inductor 1 illustrated in FIG. 1, the columnar portion 40 is present at the center of each inductor conductor layer 25, and the voids 50 are provided at both ends of the inductor conductor layer 25 between the first main surface 25a of the inductor conductor layer 25 and the insulating layers 15.

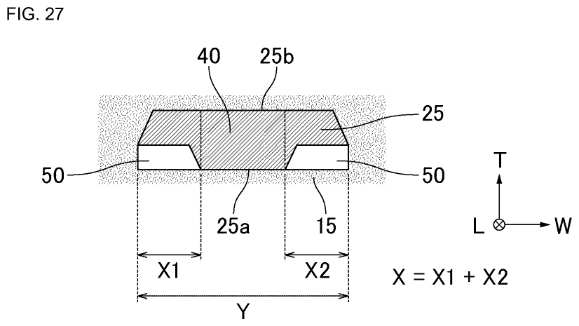

FIG. 27 is an enlarged cross-sectional view of a portion indicated by XXVII in FIG. 26.

As illustrated in FIG. 26, when looking at a cross section of the element body 10 and the inductor 20 parallel to the stacking direction T and perpendicular to the direction in which the inductor conductor layers 25 extend (length direction L in FIG. 26), in the cross section of each inductor conductor layer 25, it is preferable that a void line width ratio of an entire conductor layer expressed as X/Y be 0.16 or more and 0.96 or less (i.e., from 0.16 to 0.96), where X is the total line width of the voids 50 provided on the first main surface 25 a side of the inductor conductor layer 25 and Y is the line width of the inductor conductor layer 25, as illustrated in FIG. 27.

In the example illustrated in FIGS. 26 and 27, X=X1+X2. Here, X1 is the line width of the void 50 located on the inner periphery side of the inductor conductor layer 25, and X2 is the line width of the void 50 located on the outer periphery side of the inductor conductor layer 25.

The line width of each void 50 is the maximum length when projected onto the reference line BL (see FIG. 13). Similarly, the line width of the inductor conductor layer 25 is the maximum length when projected onto the reference line BL (see FIG. 13).

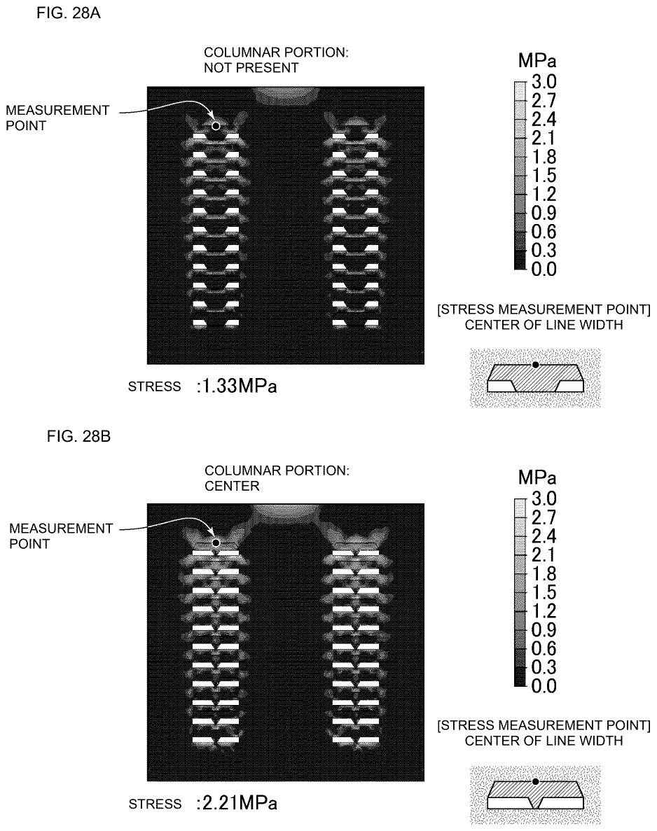

FIGS. 28A and 28B illustrate the results of stress simulations when the void line width ratio of an entire conductor layer is changed in a multilayer inductor in which columnar portions are located at the centers of the inductor conductor layers.

The results illustrated in FIGS. 28A and 28B indicate that even when the void line width ratio of the entire conductor layer is changed, the stress applied to the inductor conductor layers can be reduced compared to the configuration illustrated in FIG. 6A in which no columnar portions are present in the inductor conductor layers.

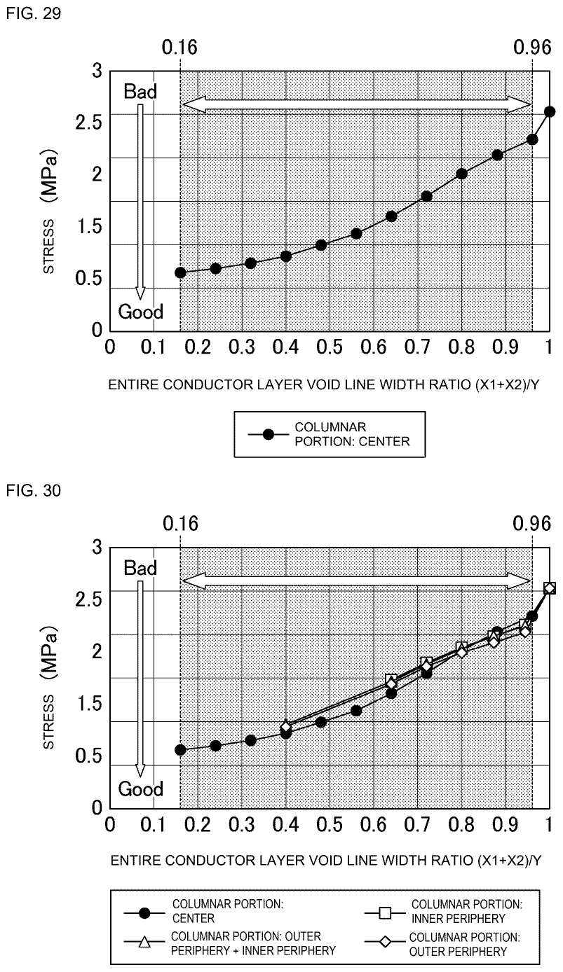

FIG. 29 is a graph illustrating the relationship between the void line width ratio of an entire conductor layer and the stress applied to the inductor conductor layers in a multilayer inductor in which columnar portions are present at the centers of the inductor conductor layers.

As can be seen from FIG. 29, in a multilayer inductor in which the columnar portions are located at the centers of the inductor conductor layers, the stress applied to the inductor conductor layers can be reduced by setting the void line width ratio of an entire conductor layer, expressed as X/Y, to 0.16 or more and 0.96 or less (i.e., from 0.16 to 0.96).

FIG. 30 is a graph illustrating the relationship between the void line width ratio of an entire conductor layer and the stress applied to the inductor conductor layers in multilayer inductors in which the columnar portions are located at different positions.

As can be seen from FIG. 30, regardless of the positions of the columnar portions, the stress applied to the inductor conductor layers can be reduced by setting the void line width ratio of an entire conductor layer, expressed as X/Y, to 0.16 or more and 0.96 or less (i.e., from 0.16 to 0.96).

### Seventh Embodiment

In a multilayer inductor according to a Seventh Embodiment of the present disclosure, in at least one cross section of the inductor conductor layers, three or more voids separated by columnar portions are provided between the first main surface of the inductor conductor layer and the insulating layers.

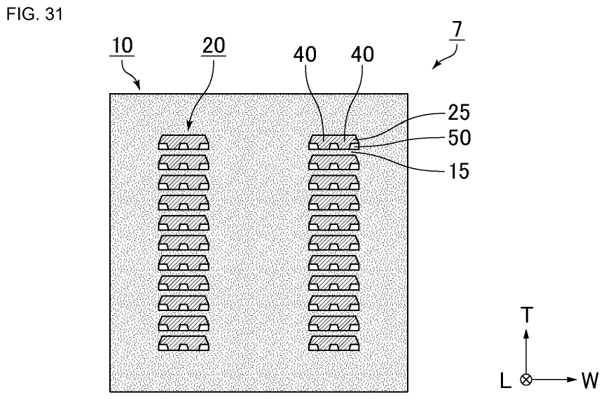

FIG. 31 is a cross-sectional view schematically illustrating an example of the multilayer inductor according to the Seventh Embodiment of the present disclosure.

In a multilayer inductor 7 illustrated in FIG. 31, when looking at a cross section parallel to the stacking direction T and perpendicular to the direction in which the inductor conductor layers 25 extend (length direction L in FIG. 31), three voids 50 that are separated from each other by columnar portions 40 in a direction along the first main surface (width direction W in FIG. 31) are provided in the cross section of each inductor conductor layer 25 between the first main surface of the inductor conductor layer 25 and the insulating layers 15.

In the example illustrated in FIG. 31, three voids 50 are provided in one cross section of the inductor conductor layers 25, but as long as three or more voids 50 are provided in at least one cross section of the inductor conductor layers 25, the number of voids 50 provided in other cross sections is not particularly limited.

FIG. 32A illustrates the results of a stress simulation for a multilayer inductor in which the number of voids separated by the columnar portions is two. FIG. 32B illustrates the results of a stress simulation for a multilayer inductor in which the number of voids separated by the columnar portions is three.

The results illustrated in FIGS. 32A and 32B indicate that even if the number of voids separated by the columnar portions changes, the stress applied to the inductor conductor layers can be reduced compared to the configuration illustrated in FIG. 6A in which no columnar portions are present in the inductor conductor layers.

An example of a method for manufacturing a multilayer inductor of the present disclosure will now be described.

In the following example, a method for manufacturing a multilayer inductor using a sheet stacking method in which insulating sheets on which inductor conductor layer patterns have been formed are stacked using insulating sheets that will become insulating layers will be described. Note that the method for manufacturing a multilayer inductor of the present disclosure is not particularly limited, and for example, a multilayer inductor may be manufactured using a print stacking method in which insulating layers and inductor conductor layer patterns are successively formed by repeatedly printing an insulating paste and then printing a conductive paste.

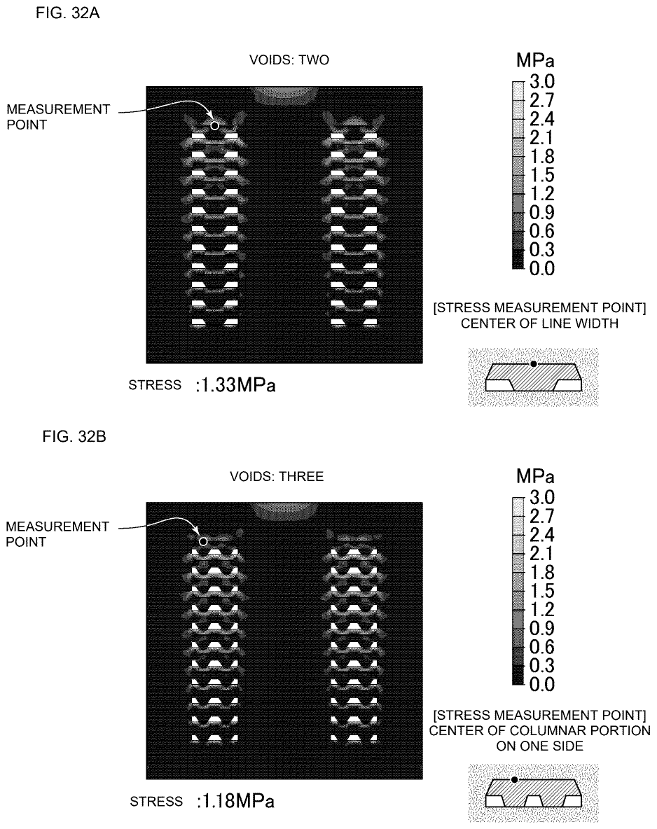

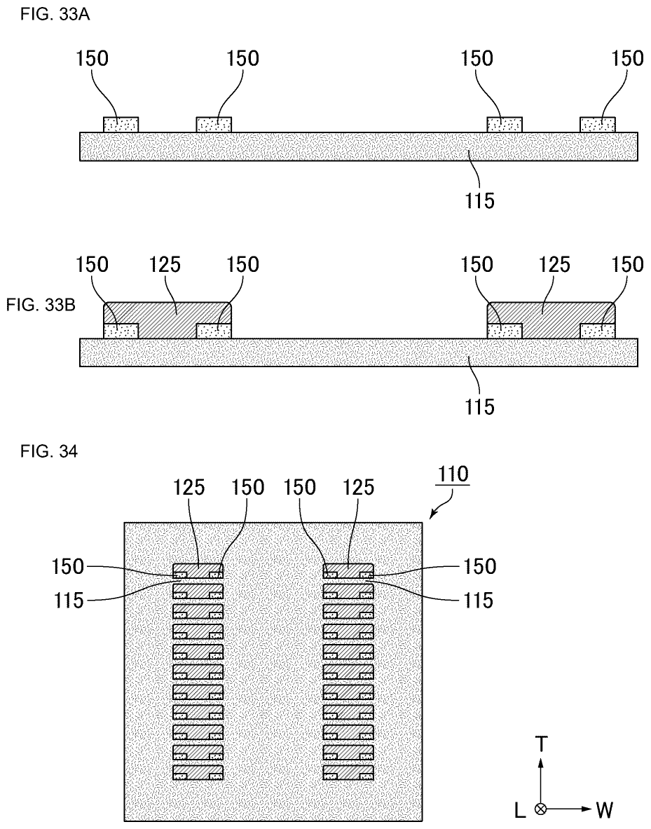

First, an example of a method for manufacturing a multilayer inductor in which no coating layer is provided on the surface of the inductor conductor layers, as in the First Embodiment of the present disclosure, will be described with reference to FIGS. 33A to 35.

FIGS. 33A and 33B are schematic diagrams illustrating an example of a printing process.

As illustrated in FIG. 33A, a resin paste layer 150 is formed by applying resin paste onto a ceramic green sheet 115. In the example illustrated in FIG. 33A, the resin paste layer 150 is formed in portions corresponding to both end portions of a conductive paste layer 125 (see FIG. 33B) described later, and the resin paste layer 150 is not formed in the center portion.

As illustrated in FIG. 33B, a conductive paste such as Ag paste is applied onto the resin paste layer 150 to form the conductive paste layer 125 so as to cover the resin paste layer 150. In this way, an inductor conductor layer pattern is formed.

Ceramic green sheets on which a plurality of inductor conductor layer patterns are formed are prepared using a method substantially the same as that illustrated in FIGS. 33A and 33B.

FIG. 34 is a schematic diagram illustrating an example of a stacking and pressure bonding process.

As illustrated in FIG. 34, the ceramic green sheets on which the plurality of inductor conductor layer patterns have been formed are stacked and pressure-bonded together. After that, the resulting multilayer body is divided into individual multilayer bodies 110.

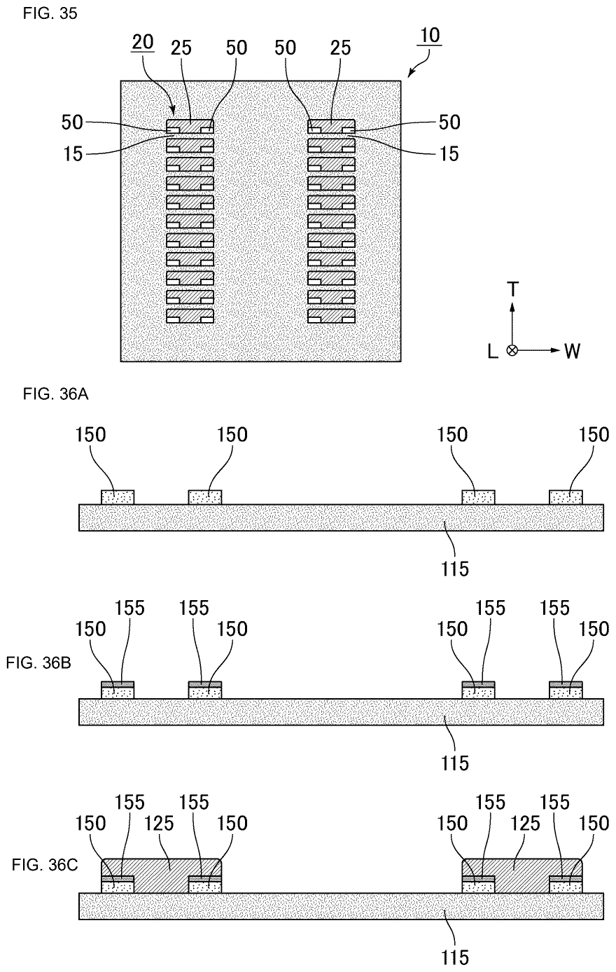

FIG. 35 is a schematic diagram illustrating an example of a firing process.

As illustrated in FIG. 35, by firing the multilayer body 110 illustrated in FIG. 34, the ceramic green sheets 115 become the insulating layers 15, and the conductive paste layers 125 become the inductor conductor layers 25. Furthermore, the voids 50 are formed in the parts corresponding to the resin paste layers 150 as the resin paste layers 150 are burned away. In the example illustrated in FIG. 35, the voids 50 are provided at both ends of the inductor conductor layers 25. In this way, the element body 10 having the inductor 20 disposed thereinside is obtained.

After firing, external electrodes are formed on the outer surfaces of the element body 10. Furthermore, plating layers may be formed on the surfaces of the external electrodes.

Through the above processes, a multilayer inductor is obtained.

Next, an example of a method for manufacturing a multilayer inductor in which a coating layer is provided on the surfaces of the inductor conductor layers as in the Second Embodiment of the present disclosure will be described with reference to FIGS. 36A to 38.

FIGS. 36A, 36B, and 36C are schematic diagrams illustrating another example of the printing process.

As illustrated in FIG. 36A, the resin paste layer 150 is formed by applying resin paste onto the ceramic green sheet 115. In the example illustrated in FIG. 36A, the resin paste layer 150 is formed in portions corresponding to both end portions of the conductive paste layer 125 (see FIG. 36C) described later, and the resin paste layer 150 is not formed in the center portion.

As illustrated in FIG. 36B, an insulating paste such as ferrite paste is applied onto the resin paste layer 150 to form an insulating paste layer 155.

As illustrated in FIG. 36C, a conductive paste such as Ag paste is applied onto the resin paste layer 150 and the insulating paste layer 155, thereby forming the conductive paste layer 125 so as to cover the resin paste layer 150 and the insulating paste layer 155. In this way, an inductor conductor layer pattern is formed.

Ceramic green sheets on which a plurality of inductor conductor layer patterns are formed are prepared using a method substantially the same as that illustrated in FIGS. 36A, 36B, and 36C.

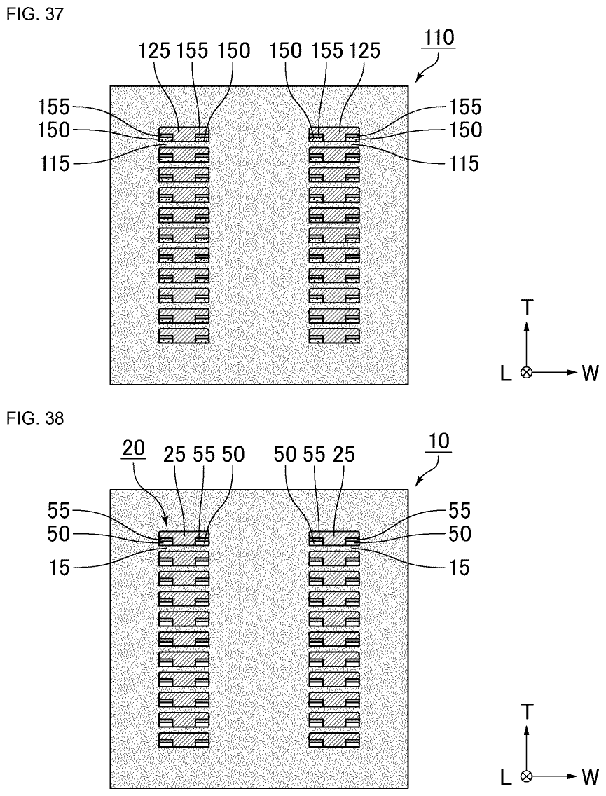

FIG. 37 is a schematic diagram illustrating another example of the stacking and pressure bonding process.

As illustrated in FIG. 37, the ceramic green sheets on which the plurality of inductor conductor layer patterns have been formed are stacked and pressure-bonded together. After that, the resulting multilayer body is divided into individual multilayer bodies 110.

FIG. 38 is a schematic diagram illustrating another example of the firing process.

As illustrated in FIG. 38, by firing the multilayer body 110 illustrated in FIG. 37, the ceramic green sheets 115 become the insulating layers 15, the conductive paste layers 125 become the inductor conductor layers 25, and the insulating paste layers 155 become the coating layers 55. Furthermore, the voids 50 are formed in the parts corresponding to the resin paste layers 150 as the resin paste layers 150 are burned away. In the example illustrated in FIG. 38, the voids 50 are provided at both ends of the inductor conductor layers 25. In this way, the element body 10 having the inductor 20 disposed thereinside is obtained.

After firing, external electrodes are formed on the outer surfaces of the element body 10. Furthermore, plating layers may be formed on the surfaces of the external electrodes.

Through the above processes, a multilayer inductor is obtained.

### Other embodiments

A multilayer inductor of the present disclosure is not limited to the above-described embodiments, and various applications and modifications can be made within the scope of the present disclosure with respect to the configurations of the element body and inductor, manufacturing conditions, and so forth.

For example, the material, shape, size, etc. of the insulating layers may be selected as appropriate depending on the application. Similarly, the material, shape, size, etc. of the inductor conductor layers may be selected as appropriate depending on the application within the scope of the present disclosure. The number of stacked inductor conductor layers is also not particularly limited.

In a multilayer inductor of the present disclosure, the number of voids may differ in the cross sections of the inductor conductor layers located in each layer. Furthermore, even for inductor conductor layers located in the same layer, the number of voids may differ in each cross section. That is, columnar portions may appear or disappear in inductor conductor layers located in the same layer. For example, even in inductor conductor layers located in the same layer, depending on the cross section being observed, there may be a cross section in which one columnar portion is present, a cross section in which no columnar portions are present, a cross section in which two or more columnar portions are present, and so forth.

In a multilayer inductor of the present disclosure, a columnar portion may be partially separated from an insulating layer. For example, minute separation called delamination may occur between a columnar portion and an insulating layer, or minute bubbles may occur. In this way, in a multilayer inductor of the present disclosure, partial non-contact between a columnar portion and an insulating layer is permitted at an unavoidable level in the manufacturing process.

In a multilayer inductor of the present disclosure, the inductor does not need to have a coil axis that is parallel to the stacking direction. For example, the inductor may be configured by stacking inductor conductor layers having a linear shape in plan view together with insulating layers in the stacking direction. In this case, the number of stacked inductor conductor layers may be one or more.

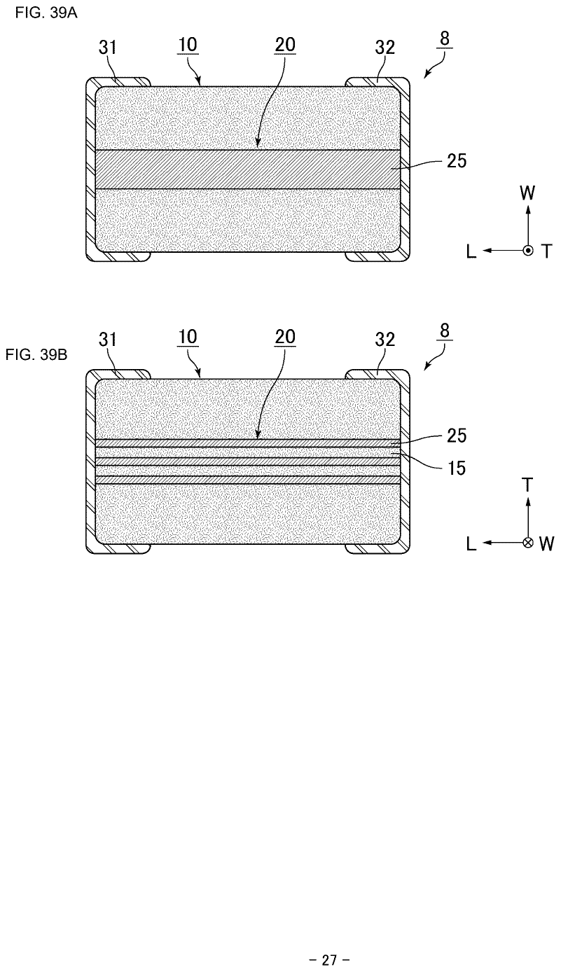

FIG. 39A is a top cross-sectional view schematically illustrating a First Modification of a multilayer inductor of the present disclosure. FIG. 39B is a side cross-sectional view schematically illustrating the First Modification of a multilayer inductor of the present disclosure.

In a multilayer inductor 8 illustrated in FIGS. 39A and 39B, the inductor 20 is formed by stacking inductor conductor layers 25 having a linear shape (for example, a shape like a straight line parallel to the length direction L) in a top view together with insulating layers 15 in the stacking direction T. The number of stacked multilayer inductor conductor layers 25 may be one or more.

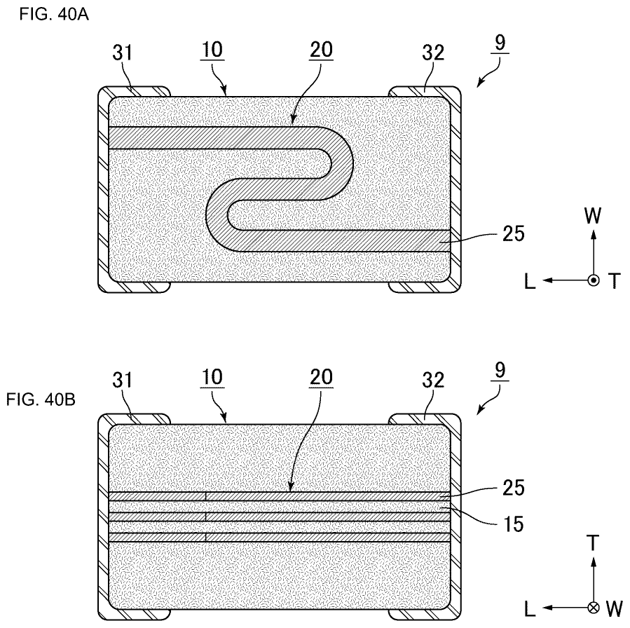

FIG. 40A is a top cross-sectional view schematically illustrating a Second Modification of a multilayer inductor of the present disclosure. FIG. 40B is a side cross-sectional view schematically illustrating the second modification of a multilayer inductor of the present disclosure.

In a multilayer inductor 9 illustrated in FIGS. 40A and 40B, the inductor 20 is formed by stacking inductor conductor layers 25, which have a curved shape (for example, meandering) when viewed from above, together with the insulating layers 15 in the stacking direction T. The number of stacked multilayer inductor conductor layers 25 may be one or more.

What is claimed is:

1. A multilayer inductor comprising:
an element body including a plurality of insulating layers stacked in a stacking direction; and
an inductor inside the element body,
wherein the inductor includes an inductor conductor layer stacked together with the insulating layers in the stacking direction, and
when looking at a cross section of the element body and the inductor parallel to the stacking direction and perpendicular to a direction in which the inductor conductor layer extends, at least one cross section of the inductor conductor layer includes a columnar portion that is in contact with the insulating layers at both a first main surface and a second main surface of the inductor conductor layer that face each other in the stacking direction, and two or more voids that are separated from each other in a direction along the first main surface by the columnar portion are between at least the first main surface of the inductor conductor layer and the insulating layers.

2. The multilayer inductor according to claim 1, further comprising:
a coating layer including an insulating material on at least a portion of a surface of the inductor conductor layer between the inductor conductor layer and the voids.

3. The multilayer inductor according to claim 2, wherein
the insulating material in the coating layer includes a magnetic material.

4. The multilayer inductor according to claim 2, wherein
the insulating material in the coating layer includes a material having an identical composition to that of the insulating layers.

5. The multilayer inductor according to claim 1, wherein
the inductor is configured by electrically connecting a plurality of the inductor conductor layers stacked together with the insulating layers in the stacking direction, and
when the inductor is viewed in a perspective view in the stacking direction, the inductor conductor layers have a spiral shape that winds around a coil axis that is parallel to the stacking direction.

6. The multilayer inductor according to claim 5, wherein
when looking at a cross section of the element body and the inductor parallel to the stacking direction and perpendicular to the direction in which the inductor conductor layers extend, in at least one pair of cross sections of the inductor conductor layers in an identical layer with the coil axis therebetween, the columnar portions in the inductor conductor layers are both at centers of the inductor conductor layers.

7. The multilayer inductor according to claim 5, wherein
when looking at a cross section of the element body and the inductor parallel to the stacking direction and perpendicular to the direction in which the inductor conductor layers extend, in at least one pair of cross sections of the inductor conductor layers in an identical layer with the coil axis therebetween, the columnar portions in the inductor conductor layers are both positioned toward outer peripheries of the inductor conductor layers.

8. The multilayer inductor according to claim 5, wherein
when looking at a cross section of the element body and the inductor parallel to the stacking direction and perpendicular to the direction in which the inductor conductor layers extend, in at least one pair of cross sections of the inductor conductor layers in an identical layer with the coil axis therebetween, the columnar portions in the inductor conductor layers are both positioned toward inner peripheries of the inductor conductor layers.

9. The multilayer inductor according to claim 6, wherein
in at least one cross section of the inductor conductor layers where the columnar portion is at a center of the inductor conductor layer, or at least one cross section of the inductor conductor layers where the columnar portion is positioned toward an outer periphery of the inductor conductor layer, or at least one cross section of the inductor conductor layers where the columnar portion is positioned toward an inner periphery of the inductor conductor layer, an inner-periphery-side void line width ratio expressed as A/(A+B) is from 0.44 to 0.63, where A is a line width of the void that is on an inner periphery side of the inductor conductor layer and B is a line width of the void that is on an outer periphery side of the inductor conductor layer.

10. The multilayer inductor according to claim 5, wherein
when looking at a cross section of the element body and the inductor parallel to the stacking direction and perpendicular to a direction in which the inductor conductor layers extend, in at least one pair of cross sections of the inductor conductor layers in an identical layer with the coil axis therebetween, the columnar portion in one of the inductor conductor layers is positioned toward an outer periphery of the inductor conductor layer, and the columnar portion in the other of the inductor conductor layers is positioned toward an inner periphery of the inductor conductor layer.

11. The multilayer inductor according to claim 1, wherein
when looking at a cross section of the element body and the inductor parallel to the stacking direction and perpendicular to a direction in which the inductor conductor layers extend, in at least one cross section of the inductor conductor layers, a void line width ratio of an entire conductor layer expressed as X/Y is from 0.16 to 0.96, where X is a total line width of the voids on the first main surface side of the inductor conductor layer and Y is the line width of the inductor conductor layer.

12. The multilayer inductor according to claim 1, wherein
when looking at a cross section parallel to the stacking direction and perpendicular to the direction in which the inductor conductor layers extend, in at least one cross section of the inductor conductor layers, three or more voids are between at least the first main surface of the inductor conductor layer and the insulating layers, the voids being separated from each other in a direction along the first main surface by the columnar portions.

13. The multilayer inductor according to claim 3, wherein
the insulating material in the coating layer includes a material having an identical composition to that of the insulating layers.

14. The multilayer inductor according to claim 2, wherein
the inductor is configured by electrically connecting a plurality of the inductor conductor layers stacked together with the insulating layers in the stacking direction, and
when the inductor is viewed in a perspective view in the stacking direction, the inductor conductor layers have a spiral shape that winds around a coil axis that is parallel to the stacking direction.

15. The multilayer inductor according to claim 3, wherein
the inductor is configured by electrically connecting a plurality of the inductor conductor layers stacked together with the insulating layers in the stacking direction, and
when the inductor is viewed in a perspective view in the stacking direction, the inductor conductor layers have a spiral shape that winds around a coil axis that is parallel to the stacking direction.

16. The multilayer inductor according to claim 4, wherein
the inductor is configured by electrically connecting a plurality of the inductor conductor layers stacked together with the insulating layers in the stacking direction, and
when the inductor is viewed in a perspective view in the stacking direction, the inductor conductor layers have a spiral shape that winds around a coil axis that is parallel to the stacking direction.

17. The multilayer inductor according to claim 7, wherein
in at least one cross section of the inductor conductor layers where the columnar portion is at a center of the inductor conductor layer, or at least one cross section of the inductor conductor layers where the columnar portion is positioned toward an outer periphery of the inductor conductor layer, or at least one cross section of the inductor conductor layers where the columnar portion is positioned toward an inner periphery of the inductor conductor layer, an inner-periphery-side void line width ratio expressed as A/(A+B) is from 0.44 to 0.63, where A is a line width of the void that is on an inner periphery side of the inductor conductor layer and B is a line width of the void that is on an outer periphery side of the inductor conductor layer.

18. The multilayer inductor according to claim 8, wherein
in at least one cross section of the inductor conductor layers where the columnar portion is at a center of the inductor conductor layer, or at least one cross section of the inductor conductor layers where the columnar portion is positioned toward an outer periphery of the inductor conductor layer, or at least one cross section of the inductor conductor layers where the columnar portion is positioned toward an inner periphery of the inductor conductor layer, an inner-periphery-side void line width ratio expressed as A/(A+B) is from 0.44 to 0.63, where A is a line width of the void that is on an inner periphery side of the inductor conductor layer and B is a line width of the void that is on an outer periphery side of the inductor conductor layer.

19. The multilayer inductor according to claim 2, wherein
when looking at a cross section of the element body and the inductor parallel to the stacking direction and perpendicular to a direction in which the inductor conductor layers extend, in at least one cross section of the inductor conductor layers, a void line width ratio of an entire conductor layer expressed as X/Y is from 0.16 to 0.96, where X is a total line width of the voids on the first main surface side of the inductor conductor layer and Y is the line width of the inductor conductor layer.

20. The multilayer inductor according to claim 2, wherein
when looking at a cross section parallel to the stacking direction and perpendicular to the direction in which the inductor conductor layers extend, in at least one cross section of the inductor conductor layers, three or more voids are between at least the first main surface of the inductor conductor layer and the insulating layers, the voids being separated from each other in a direction along the first main surface by the columnar portions.
